(19) United States
(12) Patent Application Publication
(10) Pub. No.: US 2017/0298896 A1
(43) Pub. Date: Oct. 19, 2017

(54) TIDAL CURRENT GENERATOR HAVING UNDERWATER CONNECTING STRUCTURE

(71) Applicant: Korea Institute of Ocean Science & Technology, Gyeonggi-do (KR)

(72) Inventors: Jin Hwan Ko, Seoul (KR); Jin Soon Park, Gyeonggi-do (KR); Bo Reum Won, Gyeonggi-do (KR)

(21) Appl. No.: 15/382,156

(22) Filed: Dec. 16, 2016

(30) Foreign Application Priority Data
Apr. 19, 2016 (KR) 10-2016-0047569

(51) Int. Cl. F03B 13/10; F03B 13/26; H01R 13/523; H02K 7/18

(52) U.S. Cl. CPC F03B 13/10; H02K 7/1823; F03B 13/264; H01R 13/523

(57) ABSTRACT

Disclosed herein is a tidal current power generator having an underwater connecting structure, which is capable of ensuring the promptness, correctness and safety of an electrical coupling without support by a diver. The tidal current power generator includes: a nacelle in which a turbine rotor and a power generator are installed; and a tower which is coupled to or decoupled from the nacelle. A plug connector is included in the tower. The nacelle includes a hollow tube forming a passage in which the plug connector is inserted and being filled with a nonconductive filler, a socket connector coupled to the inside of the hollow tube and connected to the power generator, and a check valve which is installed in the passage of the hollow tube and prevents the filler from escaping from the hollow tube when the plug connector is not inserted in the hollow tube.

### CROSS-REFERENCES TO RELATED APPLICATIONS

The application claims priority from Korean Application No. 10-2016-0047569 filed on Apr. 19, 2016, the disclosure of which is incorporated herein by reference.

### TECHNICAL FIELD

The present disclosure relates to a tidal current power generator having an underwater connecting structure, which is capable of ensuring the promptness, correctness and safety of an electrical coupling without support by a diver by making automatic electrical coupling between a tower and a nacelle when the tower and the nacelle are structurally coupled to each other underwater.

### BACKGROUND

A tidal current power generation system is a system which uses the flow of seawater to generate power. Unlike a tidal power generation system which uses a seawall installed in a coast and the ebb and flow of the tide to generate power, this tidal current power generation system uses a sea current to turn a turbine installed under the sea, without installing a dam or a seawall in a sea area where a fast flow of seawater appears.

The tidal current power generation system having no need to construct a seawall is assessed to be eco-friendly since it incurs lower costs, more facilitates ship's coming/going, makes less interference with the movement of fish and has less effect on the surrounding ecosystem than the tidal power generation system.

A tidal current power generator is installed according to the following procedure. First, a system line, a support structure and other devices are installed in a seabed surface. Then, a structural coupling of a nacelle to the support structure is performed along with an electrical coupling therebetween. After the installation, the nacelle is collected for maintenance and again launched. Even in this case, a structural and electrical coupling between the support structure and the nacelle is required.

In this connection, Korean Patent Reg. No. 1098148 discloses a tidal current power generator support structure which includes a cylindrical support pillar for fixing a tidal current power generator in the center by means of a number of fastening members from the top; and a rectangular plate-shaped support body for supporting the support pillar.

However, for coupling between a nacelle and the support structure disclosed in Korean Patent No. 1098148, an electrical coupling work between the support structure and the nacelle has to be performed on the water and then a structural coupling work between the support structure and the nacelle has to be performed underwater. However, this approach has a difficulty in handling an extra system line connecting the support structure and the nacelle.

Accordingly, it is desirable to perform the electrical coupling work between the support structure and the nacelle underwater. However, the underwater conditions such as electrical conductivity of seawater, poor workability in the submarine environments, a short range of vision, etc. make this underwater electrical coupling work difficult.

### SUMMARY

It is an object of the present disclosure to provide a tidal current power generator having an underwater connecting structure, which is capable of ensuring the promptness, correctness and safety of an electrical coupling without support by a diver by making automatic electrical coupling between a tower and a nacelle when the tower and the nacelle are structurally coupled to each other underwater.

In accordance with one aspect of the present disclosure, there is provided a tidal current power generator having an underwater connecting structure, including: a nacelle in which a turbine rotor and a power generator are installed; and a tower which is coupled to or decoupled from the nacelle. A plug connector is included in the tower. The nacelle includes a hollow tube forming a passage in which the plug connector is inserted and being filled with a nonconductive filler, a socket connector coupled to the inside of the hollow tube and connected to the power generator, and a check valve which is installed in the passage of the hollow tube and prevents the filler from escaping from the hollow tube when the plug connector is not inserted in the hollow tube.

In accordance with one aspect of the present disclosure, there is provided a tidal current power generator having an underwater connecting structure, including: a nacelle in which a turbine rotor and a power generator are installed; and a tower which is coupled to or decoupled from the nacelle. A plug connector connected to the power generator is included in the nacelle. The tower includes a hollow tube forming a passage in which the plug connector is inserted and being filled with a nonconductive filler, a socket connector coupled to the inside of the hollow tube, and a check valve which is installed in the passage of the hollow tube and prevents the filler from escaping from the hollow tube when the plug connector is not inserted in the hollow tube.

The check valve may include: a ring-shaped sealing member; a plurality of elastic extended parts which extend from the sealing member toward the socket connector; and a plurality of elastic membranes which extend from a pair of adjacent elastic extended parts toward the passage and are adhered to each other to seal the passage.

An annular groove in which the sealing member is inserted may be formed in the inner circumference of the hollow tube, and the elastic extended parts and the elastic membranes may surround the plug connector to seal the passage when the plug connector is inserted in the hollow tube.

The plug connector and the socket connector may be coupled to or decoupled from each other in interlock with coupling and decoupling of the nacelle and the tower. A first guide member may be formed in one of the nacelle and the tower. A second guide member may be formed in the other of the nacelle and the tower and may guide the plug connector to the socket connector while making physical contact with the first guide member when the nacelle and the tower are coupled to each other.

The first guide member may include a polygonal guide pillar portion and a polypyramidal guide inclined portion extending from the guide pillar portion. The second guide member may include an insertion groove portion in which the guide pillar portion is inserted, and an inclined groove portion which guides the guide inclined portion to the insertion groove portion.

The plug connector or the socket connector may be moved by means of a linear actuator for coupling or decoupling in a state where the nacelle and the tower are coupled to each other.

The plug connector or the hollow tube may be coupled to a guide roller which rolls along a wall of the nacelle or the tower. The linear actuator may move the guide roller.

The passage opposite to the entrance of the hollow tube may be blocked by a blocking member which is expanded or contracted depending on the flow of the filler.

According to the present disclosure, it is possible to provide a tidal current power generator having an underwater connecting structure which is capable of ensuring the promptness, correctness and safety of an electrical coupling without support by a diver by automatically coupling the plug connector and the socket connector when the tower and the nacelle are structurally coupled to each other underwater, and conserving the nonconductive filler in the hollow tube by means of the check valve.

### BRIEF DESCRIPTION OF DRAWINGS

FIG. 1 is a perspective view of a tidal current power generator having an underwater connecting structure according to one embodiment of the present disclosure.

FIG. 2 is a sectional view illustrating an electrical coupling structure of the tidal current power generator having the underwater connecting structure of FIG. 1.

FIG. 3 is a view illustrating the state of usage of a check valve of FIG. 2.

FIG. 4 is a view illustrating a coupling structure of a tidal current power generator having an underwater connecting structure according to another embodiment of the present disclosure.

FIG. 5 is a view illustrating a coupling structure of a tidal current power generator having an underwater connecting structure according to still another embodiment of the present disclosure.

### DETAILED DESCRIPTION

The above objects, features and advantages will become apparent from the detailed description with reference to the accompanying drawings. Embodiments are described in sufficient detail to enable those skilled in the art to easily practice the technical idea of the present disclosure. Detailed descriptions of well known functions or configurations may be omitted in order not to unnecessarily obscure the gist of the present disclosure. Hereinafter, embodiments of the present disclosure will be described in detail with reference to the accompanying drawings. Throughout the drawings, like reference numerals refer to like elements.

Exemplary embodiments of the present disclosure will now be described with reference to the accompanying drawings.

A tidal current power generator having an underwater connecting structure of the present disclosure is capable of ensuring the promptness, correctness and safety of an electrical coupling without support by a diver by making automatic electrical coupling between a tower and a nacelle when the tower and the nacelle are structurally coupled to each other underwater.

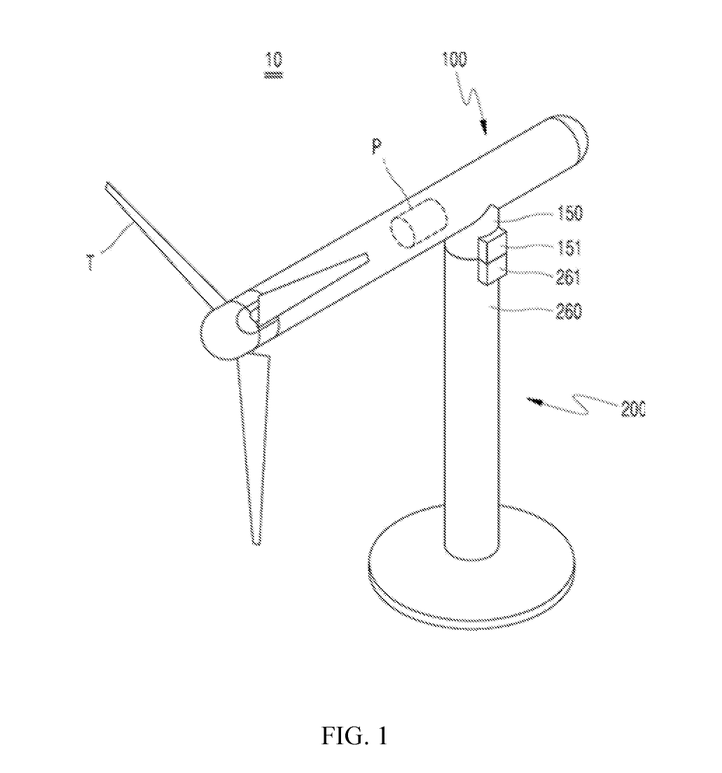

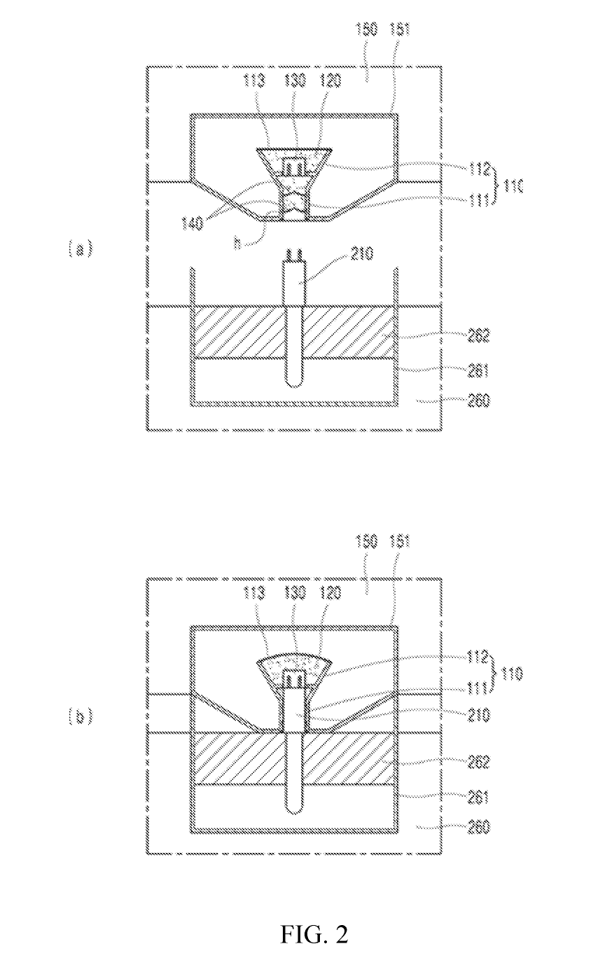

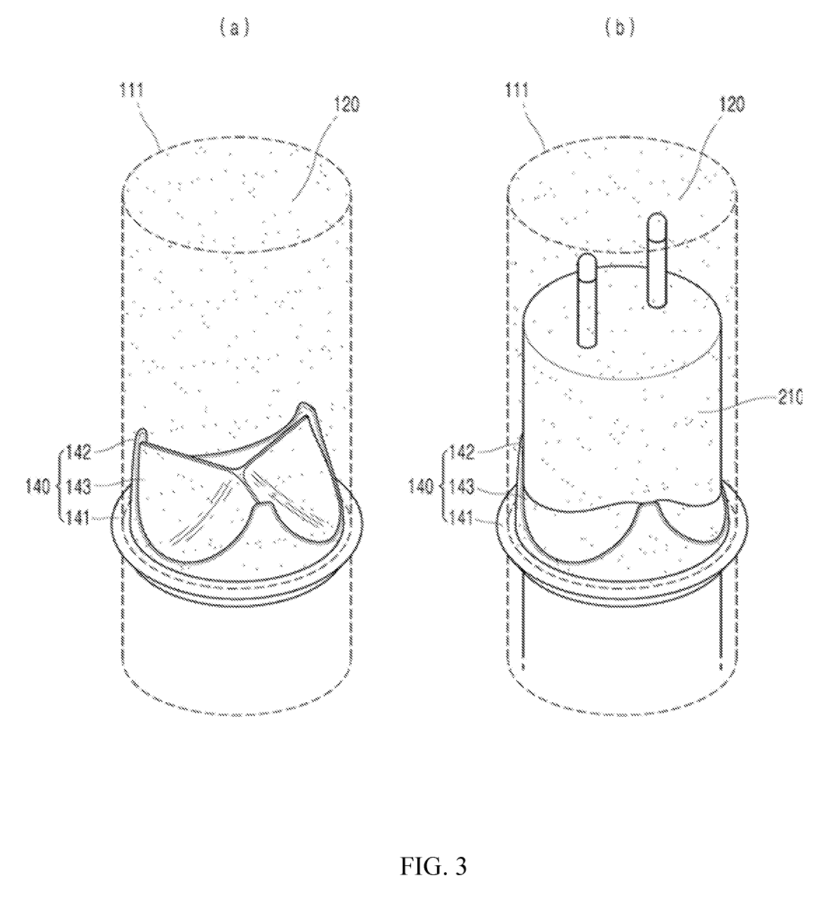

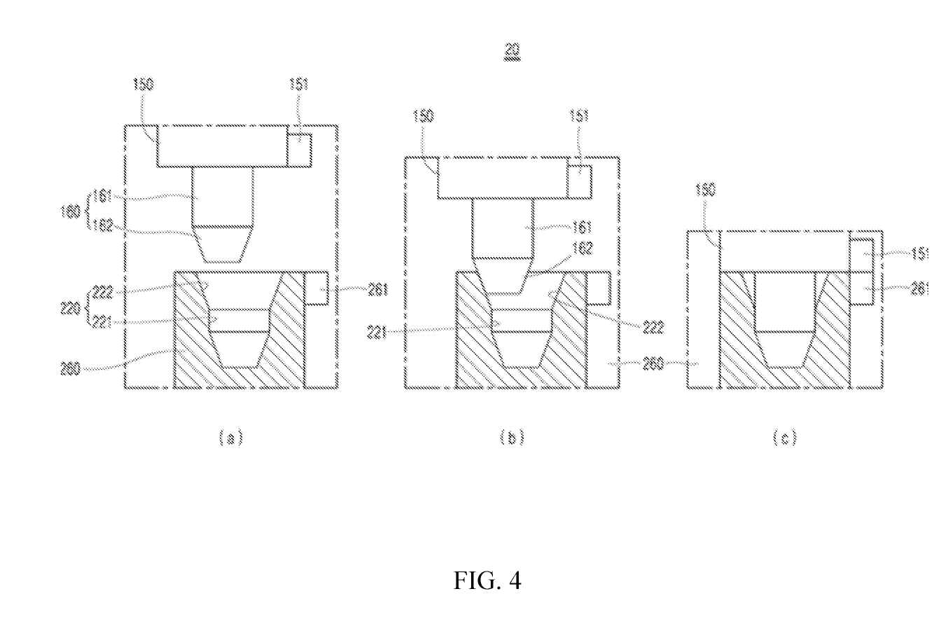

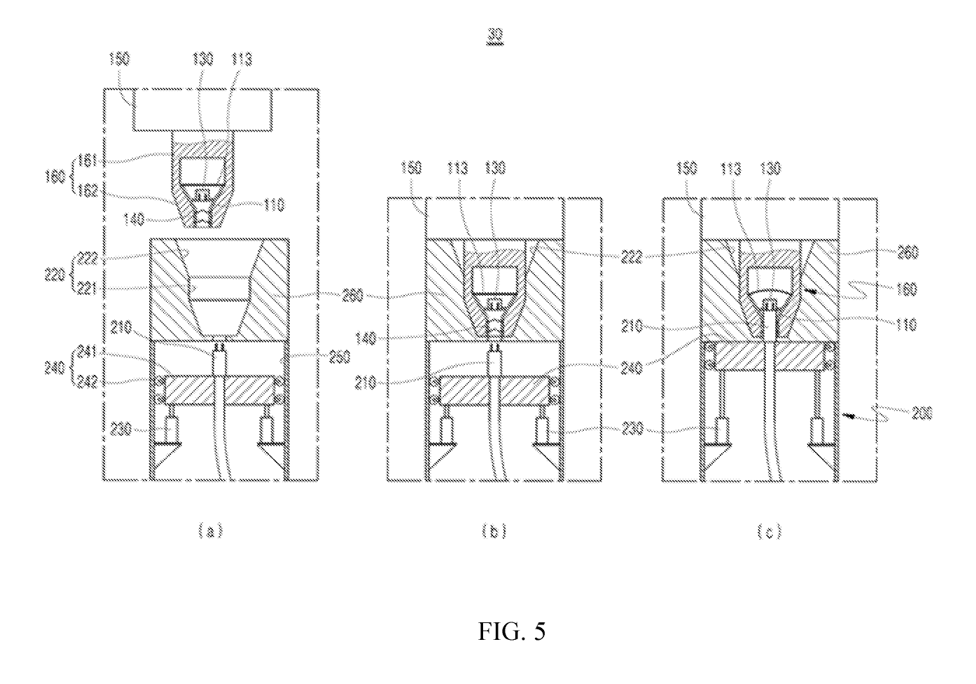

FIG. 1 is a perspective view of a tidal current power generator having an underwater connecting structure according to one embodiment of the present disclosure. FIG. 2 is a sectional view illustrating an electrical coupling structure of the tidal current power generator having the underwater connecting structure of FIG. 1. FIG. 3 is a view illustrating the state of usage of a check valve of FIG. 2. FIG. 4 is a view illustrating a coupling structure of a tidal current power generator having an underwater connecting structure according to another embodiment of the present disclosure. FIG. 5 is a view illustrating a coupling structure of a tidal current power generator having an underwater connecting structure according to still another embodiment of the present disclosure.

Referring to FIGS. 1 and 2, a tidal current power generator 10 having an underwater connecting structure according to one embodiment of the present disclosure is configured such that a plug connector 210 and a socket connector 130 are automatically coupled to each other when a tower 200 and a nacelle 100 are structurally coupled to each other underwater, thereby ensuring the promptness, correctness and safety of an electrical coupling without support by a diver.

The core technology of the present disclosure is a watertight structure in which the plug connector 210 and the socket connector 130 are water-tightly coupled to each other by means of a hollow tube 110 and a check valve 140. It should be, however, noted that the nacelle 100 and the tower 200 constituting the tidal current power generator 10 is not limited to the type and shape shown in the figures.

The nacelle 100 includes a turbine rotor T and a power generator P and is connected via a connector 150 to a coupling end 260 of the tower 200 installed on a seabed surface. Here, the connector 150 and the coupling end 260 are parts formed in the nacelle 100 and the tower 200 in order to structurally couple the nacelle 100 and the tower 200. Although not shown, the connector 150 and the coupling end 260 can be fastened to each other by means of fastening bolts in the structural coupling of the nacelle 100 to the tower 200.

The plug connector 210 and the socket connector 130 are used to transmit power from the power generator P via the tower 200. When one of the plug connector 210 and the socket connector 130 is installed in the nacelle 100, the other is installed in the tower 200. For example, the plug connector 210 may be installed in the nacelle 100 and the hollow tube 110, the socket connector 130 and the check valve 140 may be installed in the tower 200. The following description will be given to a case where the plug connector 210 is installed in the tower 200 and the hollow tube 110, the socket connector 130 and the check valve 140 are installed in the nacelle 100.

The plug connector 210 and the socket connector 130 are coupled to each other when the tower 200 and the nacelle 100 are structurally coupled to each other. Accordingly, the plug connector 210 and the socket connector 130 have the same coupling direction as the coupling end 260 and the connector 150. The following description will be given to a case where the coupling end 260 is formed on the top of the tower 200 and the nacelle 100 is descended to make the structural coupling with the tower 200.

As illustrated in FIGS. 1 and 2, the socket connector 130 is installed in a first cover 151 formed in the outer surface of the connector 150 and the plug connector 210 is installed in a second cover 261 formed in the outer surface of the coupling end 260. The first cover 151 and the second cover 261 are provided to protect the socket connector 130 and the plug connector 210 from the underwater environments.

As illustrated in FIG. 2, the plug connector 210 is coupled to the socket connector 130 in order to transmit the power from the power generator P. The plug connector 210 is combined to a support 262 in the second cover 261 and projects in the direction of coupling with the socket connector 130, i.e., upward. A wire connected with the plug connector 210 is inserted into the tower 200 in the second cover 261.

The socket connector 130 is used to transmit the power from the power generator P via the plug connector 210 and is coupled to the inside of the hollow tube 110 in the first cover 151.

As illustrated in FIG. 2, the hollow tube 110 forms a space in which the socket connector 130 is installed, and includes a linear part 111 and an extended part 112.

The linear part 111 forms a vertical passage in which the plug connector 210 is inserted, and has a hole opened downward. The plug connector 210 is inserted in the hollow tube 110 via the opened hole of the linear part 111. The extended part 112 forms a space extending upward from the top of the linear part 111. The socket connector 130 is coupled to the inside of the extended part 112.

The hollow tube 110 is filled with nonconductive filler 120 such as nonconductive grease or the like. The filler 120 is prevented from draining out through the opened bottom by means of the check valve 140 installed in the passage of the hollow tube 110.

The socket connector 130 is entirely immersed in the filler 120 in the hollow tube 110. The top of the extended part 112 can be opened so that the level of the filler 120 can be smoothly varied when the plug connector 210 is inserted in the hollow tube 110.

The top of the extended part 112 may be blocked by a blocking member 113 as shown in FIG. 2A. The blocking member 113 is made of a material which can be expanded/contracted depending on the flow of the filler 120, such as rubber or silicone. When the blocking member 113 is formed on the top of the extended part 112, the filler 120 is fully filled in the extended part 112 and the blocking member 113.

In a state where the blocking member 113 is contracted when the plug connector 210 is not inserted, the blocking member 113 presses the filler 120. Before the plug connector 210 is inserted in the passage of the hollow tube 110, seawater may be introduced in the passage through the check valve 140 due to a water pressure underwater. In this case, the pressure of the blocking member 113 formed on the top of the extended part 112 balances the water pressure, thereby preventing the seawater from being introduced in the passage. As illustrated in FIG. 2B, the blocking member 113 is expanded when the plug connector 210 is inserted. Instead of using the blocking member 113, a way to pressurize the interior of the first cover 151 may be used to minimize the introduction of the seawater due to the water pressure.

As illustrated in FIG. 2A, the check valve 140 is provided to prevent the filler 120 from escaping from the hollow tube 110 irrespective of whether or not the plug connector 210 is inserted. The number of check valves 140 installed in the passage of the hollow tube 110 is one or more. As illustrated in FIG. 3, the check valve 140 includes a sealing member 141, a plurality of elastic extended parts 142 and elastic membranes 143.

The sealing member 141 has a ring shape and is fitted in an annular groove h formed on the inner circumference of the hollow tube 110. The sealing member 141 is made of an elastic material such as rubber or silicone. In a state where the sealing member 141 is fitted in the annular groove h, the sealing member 141 is elastically adhered to the inner circumference of the hollow tube 110. A metal frame (not shown) to maintain the stiffness of the sealing member 141 may be preferably included in the sealing member 141.

Each of the elastic extended parts 142 corresponds to an extension of each of the elastic membranes 143 and has a roughly triangular shape to extend from the sealing member 141 toward the socket connector 130. The number of elastic extended parts 142 may be preferably three. Both side ends of each of the elastic extended parts 142 are connected to both side ends of an adjacent elastic extended part 142.

The outer surface of each elastic extended part 142 is made of an elastic material such as rubber or silicone. As illustrated in FIG. 3B, in a state where the plug connector 210 is inserted in the hollow tube 110, the outer surface of each elastic extended part 142 is adhered to the outer circumference of the plug connector 210. A metal frame (not shown) to maintain the stiffness of the elastic extended part 142 may be preferably included in the elastic extended part 142.

Each of the elastic membrane 143 is provided to seal the passage and extends from a pair of adjacent elastic extended parts 142 toward the passage. As illustrated in FIG. 3A, when the plug connector 210 is not inserted, the elastic membranes 143 are adhered to each other by elasticity (or the weight of the filler 210 or the internal pressure of the first cover 151), thereby preventing the filler 120 from escaping from the hollow tube 110, as illustrated in FIG. 2B.

When the plug connecter 210 is inserted in the hollow tube 110 as illustrated in FIG. 2B, the elastic membranes 143 are elastically deformed to form a path through which the plug connector 210 passes, as illustrated in FIG. 3B. At this time, the elastic extended parts 142 and the elastic membranes 143 surround the plug connector 210 to seal the passage, thereby preventing the filler 120 from escaping from the hollow tube 110.

Each elastic membrane 143 is made of a material exhibiting a hyper-elastic behavior. Specifically, the outside of the elastic membrane 143 is made of an elastically deformable material such as rubber or silicone and the inside of the elastic membrane 143 is constituted by a mesh made of a hyper-elastic shape memory alloy, thereby providing a force of restitution to water-tightly seal the passage of the elastic membrane 143. The hyper-elastic shape memory alloy mesh may be formed of a nitinol wire or the like.

As illustrated in FIG. 4, in a tidal current power generator 20 according to another embodiment of the present disclosure, a first guide means 160 may be included in one of the nacelle 100 and the tower 200 and a second guide means 220 may be included in the other.

The first guide means 160 and the second guide means 220 are provided to correctly guide the plug connector 210 to the socket connector 130 while making physical contact with each other when the nacelle 100 and the tower 200 are coupled to each other. The following description will be given to a case where the first guide means 160 is formed in the connector 150 and the second guide means 220 is formed in the coupling end 260.

As illustrated in FIG. 4A, the first guide means 160 includes a guide pillar portion 161 and a guide inclined portion 162.

The guide pillar portion 161 has a polygonal pillar shape projecting downward from the bottom of the connector 150 and the guide inclined portion 162 has a polypyramidal shape projecting downward from the bottom of the guide pillar portion 161.

The second guide means 220 includes an insertion groove portion 221 and an inclined groove portion 222.

The insertion groove portion 221 is a portion in which the guide pillar portion 161 is inserted. In a state where the guide pillar portion 161 is inserted in the insertion groove portion 221, the inner circumference of the insertion groove portion 221 supports the outer circumference of the guide pillar portion 161.

The inclined groove portion 222 is a portion to guide the guide inclined portion 162 to the insertion groove portion 221, as illustrated in FIG. 4B. The inclined groove portion 222 forms an inclined plane extended from the top of the inner circumference of the insertion groove portion 221 with the same slope as the guide inclined portion 162.

While the nacelle 100 is being descended over the tower 200 by means of a crane (not shown), as illustrated in FIG. 4A, the guide inclined portion 162 is first slidably descended in contact with the inclined groove portion 222, as illustrated in FIG. 4B.

When the guide inclined portion 162 completely enters the insertion groove portion 221 through the inclined groove portion 222, the guide pillar portion 161 is inserted into the insertion groove portion 221, following the guide inclined portion 162.

While the guide pillar portion 161 is being inserted in the insertion groove portion 221, the socket connector 130 and the plug connector 210 make exact mutual vertical alignment, which results in complete insertion of the first guide means 160 in the second guide means 220, as illustrated in FIG. 4C, completing the coupling of the socket connector 130 and the plug connector 210, as illustrated in FIG. 2B.

As illustrated FIG. 5, in a tidal current power generator 30 according to still another embodiment of the present disclosure, in a state where the nacelle 100 and the tower 200 are coupled to each other, the plug connector 210 or the socket connector 130 may be moved by a linear actuator 230 for coupling or decoupling. The following description will be given to a case where the plug connector 210 is vertically moved by the linear actuator 230.

In addition, in the tidal current power generator 30 according to still another embodiment of the present disclosure, the socket connector 130 is installed inside the first guide means 160 and the plug connector 210 is installed inside the coupling end 260 below the second guide means 220.

As illustrated in FIG. 5A, the lower end of the linear part 111 of the hollow tube 110 is formed on the lower end of the guide inclined portion 162. For the purpose of brevity, explanation about the same configuration as the above embodiment of the present disclosure will not be repeated.

A hole through which the plug connector 210 is vertically moved is formed in the lower end surface of the insertion groove portion 221. As illustrated in FIG. 5B, the plug connector 210 is located below the hole before the first guide means 160 completely enters the second guide means 220.

The plug connector 210 is coupled to a guide roller 240 which rolls along a wall 250 of the tower 200. The guide roller 240 includes a body 241 to which the plug connector 210 is fixed, and a plurality of wheels 242 formed in the side of the body 241.

As illustrated in FIG. 5B, the socket connector 130 and the plug connector 210 make exact mutual vertical alignment while the guide pillar portion 161 is being inserted in the insertion groove portion 221.

As illustrated in FIG. 5C, the guide roller 240 is vertically moved by means of the linear actuator 230 (after the first guide means 160 is completely inserted in the second guide means 220), thereby making the exact mutual vertical alignment of the plug connector 210 and the socket connector 130.

According to the above embodiments of the present disclosure, it is possible to provide a tidal current power generator having an underwater connecting structure which is capable of ensuring the promptness, correctness and safety of an electrical coupling without support by a diver by automatically coupling a plug connector and a socket connector when a tower and a nacelle are structurally coupled to each other underwater, and conserving a nonconductive filler in a hollow tube by means of a check valve.

While the present invention has been particularly shown and described with reference to exemplary embodiments thereof, it will be understood by those skilled in the art that various changes in form and details may be made therein without departing from the spirit and scope of the present invention. The exemplary embodiments are provided for the purpose of illustrating the invention, not in a limitative sense. Thus, it is intended that the present invention covers the modifications and variations of this invention provided they come within the scope of the appended claims and their equivalents.

What is claimed is:

1. A tidal current power generator having an underwater connecting structure, comprising:
a nacelle in which a turbine rotor and a power generator are installed; and
a tower which is coupled to or decoupled from the nacelle,
wherein a plug connector is included in the tower, and
wherein the nacelle includes a hollow tube forming a passage in which the plug connector is inserted and being filled with a nonconductive filler, a socket connector coupled to the inside of the hollow tube and connected to the power generator, and a check valve which is installed in the passage of the hollow tube and prevents the filler from escaping from the hollow tube when the plug connector is not inserted in the hollow tube.

2. The tidal current power generator according to claim 1, wherein the check valve includes:
a ring-shaped sealing member;
a plurality of elastic extended parts which extend from the sealing member toward the socket connector; and
a plurality of elastic membranes which extend from a pair of adjacent elastic extended parts toward the passage and are adhered to each other to seal the passage.

3. The tidal current power generator according to claim 2, wherein an annular groove in which the sealing member is inserted is formed in the inner circumference of the hollow tube, and
wherein the elastic extended parts and the elastic membranes surround the plug connector to seal the passage when the plug connector is inserted in the hollow tube.

4. The tidal current power generator according to claim 1, wherein the plug connector and the socket connector are coupled to or decoupled from each other in interlock with coupling and decoupling of the nacelle and the tower,
wherein a first guide member is formed in one of the nacelle and the tower, and
wherein a second guide member is formed in the other of the nacelle and the tower, the second guide member guiding the plug connector to the socket connector while making physical contact with the first guide member when the nacelle and the tower are coupled to each other.

5. The tidal current power generator according to claim 4, wherein the first guide member includes a polygonal guide pillar portion and a polypyramidal guide inclined portion extending from the guide pillar portion, and
wherein the second guide member includes an insertion groove portion in which the guide pillar portion is inserted, and an inclined groove portion which guides the guide inclined portion to the insertion groove portion.

6. The tidal current power generator according to claim 1, wherein the plug connector or the socket connector is moved by means of a linear actuator for coupling or decoupling in a state where the nacelle and the tower are coupled to each other.

7. The tidal current power generator according to claim 6, wherein the plug connector or the hollow tube is coupled to a guide roller which rolls along a wall of the nacelle or the tower, and
wherein the linear actuator moves the guide roller.

8. The tidal current power generator according to claim 1, wherein a passage opposite to the entrance of the hollow tube is blocked by a blocking member which is expanded or contracted depending on the flow of the filler.

9. A tidal current power generator having an underwater connecting structure, comprising:
a nacelle in which a turbine rotor and a power generator are installed; and
a tower which is coupled to or decoupled from the nacelle,
wherein a plug connector connected to the power generator is included in the nacelle, and
wherein the tower includes a hollow tube forming a passage in which the plug connector is inserted and being filled with a nonconductive filler, a socket connector coupled to the inside of the hollow tube, and a check valve which is installed in the passage of the hollow tube and prevents the filler from escaping from the hollow tube when the plug connector is not inserted in the hollow tube.

10. The tidal current power generator according to claim 9, wherein the check valve includes:
a ring-shaped sealing member;
a plurality of elastic extended parts which extend from the sealing member toward the socket connector; and
a plurality of elastic membranes which extend from a pair of adjacent elastic extended parts toward the passage and are adhered to each other to seal the passage.

11. The tidal current power generator according to claim 10, wherein an annular groove in which the sealing member is inserted is formed in the inner circumference of the hollow tube, and
wherein the elastic extended parts and the elastic membranes surround the plug connector to seal the passage when the plug connector is inserted in the hollow tube.

12. The tidal current power generator according to claim 9, wherein the plug connector and the socket connector are coupled to or decoupled from each other in interlock with coupling and decoupling of the nacelle and the tower,
wherein a first guide member is formed in one of the nacelle and the tower, and
wherein a second guide member is formed in the other of the nacelle and the tower, the second guide member guiding the plug connector to the socket connector while making physical contact with the first guide member when the nacelle and the tower are coupled to each other.

13. The tidal current power generator according to claim 12, wherein the first guide member includes a polygonal guide pillar portion and a polypyramidal guide inclined portion extending from the guide pillar portion, and
wherein the second guide member includes an insertion groove portion in which the guide pillar portion is inserted, and an inclined groove portion which guides the guide inclined portion to the insertion groove portion.

14. The tidal current power generator according to claim 9, wherein the plug connector or the socket connector is moved by means of a linear actuator for coupling or decoupling in a state where the nacelle and the tower are coupled to each other.

15. The tidal current power generator according to claim 14, wherein the plug connector or the hollow tube is coupled to a guide roller which rolls along a wall of the nacelle or the tower, and
wherein the linear actuator moves the guide roller.

16. The tidal current power generator according to claim 9, wherein a passage opposite to the entrance of the hollow tube is blocked by a blocking member which is expanded or contracted depending on the flow of the filler.
